(19) United States
(12) Patent Application Publication
(10) Pub. No.: US 2025/0022637 A1
(43) Pub. Date: Jan. 16, 2025

(54) PTC SEMICONDUCTOR CERAMIC COMPOSITION, METHOD FOR PRODUCING THE SEMICONDUCTOR CERAMIC AND HEATING DEVICE AND USE

(71) Applicant: MAHLE International GmbH, Stuttgart (DE)

(72) Inventors: Hans-Heinrich Angermann, Stuttgart (DE); Klaus Wintrich, Bad Soden-Salmuenster (DE); Torben Seifert, Bad Saeckingen (DE)

(21) Appl. No.: 18/772,101

(22) Filed: Jul. 12, 2024

(30) Foreign Application Priority Data
Jul. 14, 2023 (DE) 102023118776.7

(51) Int. Cl. H01C 7/02; C04B 35/468; C04B 35/64

(52) U.S. Cl. CPC H01C 7/025; C04B 35/4682; C04B 35/64; C04B 2235/3224; C04B 2235/604

(57) ABSTRACT

A semiconductor ceramic composition may include, as a main component, a BaTiO₃-based compound according to the formula [Ba_{b}Ca_{c}SrₛPbₚRₓ][TiₜAₐMnₘ]O_{3+z}. R may represent at least one element selected from a group consisting of Y, La, Ce, Pr, Nd, Sm, Eu, Gd, Tb, Dy, Ho, Er, Tm, and Yb. A may represent at least one element selected from a group consisting of V, Nb, and Ta. The variables b, c, s, p, x, t, a, m, and z may be defined as: b=1−c−s−p−x; 0<c+s+p<0.51; 0.490<b<0.999; 0.0<c<0.5; 0.0<s<0.5; 0.05<p<0.5; 0.001<x<0.01; 1.0001<(t+a+m)<1.011575; 0.9889<t<1.000375; 0.00010<a<0.0012; 0.0001<m<0.01; and 0.0001<z<0.01.

### CROSS-REFERENCE TO RELATED APPLICATION

This application claims priority to German Patent Application No. DE102023118776.7, filed on Jul. 14, 2023, the contents of which is hereby incorporated by reference in its entirety.

### TECHNICAL FIELD

The invention relates to a PTC semiconductor ceramic composition, a method for producing the corresponding PTC semiconductor ceramic, the use of the PTC semiconductor ceramic, and a heating apparatus comprising the PTC semiconductor ceramic, according to the class of the independent claims.

### BACKGROUND

Semiconductor ceramics whose electrical conductivity decreases with increasing temperature due to increasing resistance exhibit a thermal self-regulation that can be used as a heating element during application. This effect is also called the positive temperature coefficient (PTC) effect. Due to the fact that, for the motor vehicles with an internal combustion engine that were previously primarily used, the waste heat generated in the engine can be used for heating the cabin, PTC heating elements in the past were only used as an auxiliary heat system for rapid heating or during cold outside temperatures. Such additional heating elements are usually designed for an on-board power supply in the low voltage range (typically with voltages up to 48 volts). For example, DE 10 2014 110 164 A1 relates to a heating apparatus having a PTC heating resistor and a method for producing a heating rod, which can be used in order to heat a passenger cabin.

However, for electric vehicles, there is no waste heat from an internal combustion engine available. Nevertheless, heat is required in order to keep the cabin of the vehicle warm and to temperature-control the battery. In electric vehicles, significantly higher on-board power supply voltages are also used. For example, on-board power supply voltages of nominally up to 350 volts are used in passenger cars, and voltages of nominally 800 volts are being sought in the meantime (high-voltage range). This is due, among other things, to the fact that an increased battery voltage shortens the battery charging time and increases the usable battery life, and the power density can also be increased. PTC components used in the past can either not achieve these voltage requirements or can only achieve them by using a significantly larger component thickness.

### SUMMARY

The problem addressed by the present invention is to indicate new ways in the development of PTC semiconductor ceramic compositions for a PTC semiconductor ceramic as well as the corresponding method for producing the ceramic and a corresponding heating apparatus in order to improve their thermal and/or electrical properties.

According to the invention, this problem is solved by the subject-matter of the independent patent claim(s). Advantageous embodiments are the subject of the dependent patent claim(s).

According to the invention, a semiconductor ceramic composition is provided, wherein the semiconductor ceramic composition comprises as the main component a BaTiO₃-based compound according to the following formula:

[Ba_{b}Ca_{c}SrₛPbₚRₓ][TiₜAₐMnₘ]O_{3+z},

wherein R represents at least one element selected from the group consisting of Y, La, Ce, Pr, Nd, Sm, Eu, Gd, Tb, Dy, Ho, Er, Tm, Yb,
and wherein A represents at least one element selected from the group consisting of V, Nb, and Ta, and wherein the variables b, c, s, p, x, t, a, m, and z are defined as follows:

$$b = 1 - c - s - p - x$$

$$0 < c + s + p < 0.51$$

$$0.49 < b < 0.9 \; 99$$

$$0. < c < 0.5$$

$$0. < s < 0.5$$

$$0.05 < p < 0.5$$

$$0.001 < x < 0.01$$

$$1.0001 < ( t + a + m ) < 1.011575$$

$$0.9889 < t < 1.000375$$

$$0.0001 < a < 0.0 \; 012$$

$$0.0001 < m < 0.01$$

$$0.0001 < z < 0.01 .$$

Compared to the prior art, the semiconductor ceramic composition according to the invention having the features of the independent claim 1 has the essential advantage that it has a high punch-through voltage and a good self-regulation and thus allows for an application in a heating element for operation at high stresses up to the high-voltage range. At the same time, no excessive increase in the component thickness is necessary.

In the context of the present invention, the punch-through voltage of a PTC ceramic is understood to be the voltage at which a steep increase in current can be observed after reaching a constant current in the control range of the material with a further voltage increase beyond Uₘₐₓ, which leads to irreversible damage to the ceramic. This is shown schematically in FIG. 1. At the same time, the PTC ceramics have the special feature that their resistance increases suddenly at a certain temperature. This enables a self-regulation, because an increasing current also leads to a higher temperature, whereupon the resistance of the material increases and the current flow decreases. The punch-through voltage can be influenced both by the material thickness and by the material composition itself. This will be discussed in more detail later.

A further significant advantage is therefore that a heating element can be operated directly at the on-board voltage based on the semiconductor ceramic composition according to the invention, even when a higher on-board voltage is used. Costs and sources of error can thus be avoided, because no elaborate safety and control technology, for example for conversion into a lower voltage range, are required.

In addition, based on the semiconductor ceramic composition according to the invention, a heating element has the essential advantage that no excessively larger component thickness is necessary for a high punch-through voltage. As a result, a higher component weight can be avoided. In addition, a greater air resistance, due to a larger component thickness, for example when used in a heating fan with the associated air duct, can also be avoided.

Furthermore, a higher material need and the correspondingly increased costs and the increased energy need during production can be avoided. Furthermore, thermal stresses within the material caused by a large component thickness and the resulting wear are significantly reduced.

In addition, based on the semiconductor ceramic composition according to the invention, the use of a heating element enables an optimum temperature control of the battery in the charging and driving state. Alternatively, however, the heating element can also advantageously only be used as a cabin heating system, wherein a lower air output is required due to an advantageous savings in terms of weight and size of the ceramic.

This also results in a significant advantage that the service life of the battery and the range of the corresponding vehicles can be significantly increased.

This is achieved in particular by specifying a semiconductor ceramic composition, with which higher punch-through voltages can be achieved with simultaneous good self-regulation.

In the following, the semiconductor ceramic composition according to the invention, the method for producing the PTC semiconductor ceramic and the corresponding sintered body, the use of the PTC semiconductor ceramic, and a heating apparatus comprising the PTC semiconductor ceramic are explained in greater detail, wherein the figures used for the explanation of the ceramic according to the invention and in this context also apply analogously to the method and to the use, and the figures used in this context apply vice versa.

The present invention is based on the general concept of providing a semiconductor ceramic that has a steep increase in its resistance in the range of its Curie temperature and a high punch-through voltage and is also suitable for use in high-voltage ranges up to the high-voltage range, without the need to excessively increase the thickness of the ceramic used. Because PTC components should normally also have a safety factor of the punch-through voltage, the punch-through voltage is usually defined as approx. twice the on-board power supply voltage. At an on-board voltage of 350 volts, a punch-through voltage of at least 650 volts, and at an on-board voltage of 800 volts even 1400 volts, is required.

Typically, the effect of a strong increase in resistance of such PTC ceramic occurs in the range of a phase conversion. At a temperature significantly below the phase conversion, there is a typical NTC (Negative Temperature Coefficient) semiconductor behavior, and the resistance thus drops as the temperature rises. In the range after the strong increase in resistance, there is also a typical NTC semiconductor behavior. The special effect of a strong PTC resistance increase between the two NTC ranges, and thus a strong current reduction at a given voltage, can be used for self-regulation of a heating element, because it prevents the power output of the heating element from continuously increasing with increasing current until, for example, a fire ultimately occurs.

The PTC effect occurs, for example, in compounds based on BaTiO₃ and represents a grain boundary effect coupled with a phase conversion. Pure BaTiO₃ has a phase transition from a tetragonal into a cubic crystal structure at about 120° C., the so-called Curie temperature. The cubic crystal structure of the BaTiO₃ is a typical example of the ideal cubic perovskite structure. The titanium (IV) cation is located in the center of an octahedron, the corners of which are formed by oxide ions. The barium (II) cation, on the other hand, is located in the center of a cuboctahedron formed from oxide ions. For compounds having a different composition, it is also conceivable that other cations and anions occur with charges that are different than the ion charges mentioned here. In the tetragonal structure, there is a distortion, wherein, among other things, a deviation from the ideal octahedral geometry of the octahedron around the Ti(IV) cation is observed. As a result, the titanium (IV) cations are no longer exactly in the center of the octahedron, the charge focal points of Ti and O do not lie on top of one another, and the BaTiO₃ is a ferroelectric in the tetragonally distorted modification (see below). This is no longer the case in the cubic modification.

Pure BaTiO₃ has a band gap of approx. 3 eV and thus a low electrical conductivity. Doped BaTiO₃ is therefore typically used. Doping refers to the introduction of foreign atoms into a base material. For example, such a foreign atom can have a number of valence electrons that differs from the number of valence electrons of the corresponding element of the base material. BaTiO₃ is usually doped with donor foreign atoms, which means that, for example, an atom having three valence electrons is introduced onto a barium site, whereas a barium atom itself has only two valence electrons. However, it is also possible to substitute the Ti having four valence electrons with a pentavalent element, which also means a donor doping. Through sintering at high partial oxygen pressures, barium and oxygen vacancies can be formed at the same time, the concentration of which is highest at the grain boundaries. In this context, a vacancy is understood to mean that the actual site provided for an element in the crystal structure remains empty at this point. If a material, such as in a ceramic, is present in polycrystalline form, then the material contains a plurality of grain boundaries, which for example separate individual crystalline regions having different orientations from one another. The introduced vacancies can now serve as acceptors, because the valence electrons of the element normally present at this site are missing. In its tetragonal form, i.e. under normal pressure below 120° C., BaTiO₃ is a ferroelectric, and it can thus form regions having the same polarization direction. The resulting polarization charges can compensate the negative grain boundary charges due to the aforementioned vacancies. The conversion into the cubic crystal structure eliminates the ferroelectric property. The negative grain boundary charges can no longer be compensated by polarization charges, but must instead be compensated by the donors introduced by doping. As a result, the resistance increases abruptly at the phase conversion temperature.

The semiconductor ceramic composition according to the invention now comprises as the main component a BaTiO₃-based compound according to the following formula:

[Ba_{b}Ca_{c}SrₛPbₚRₓ][TiₜAₐMnₘ]O_{3+z}.

The main component here is the predominantly already existing compound. It goes without saying that such a semiconductor ceramic composition can have small amounts of impurities having other compounds. For example, it is conceivable that such a semiconductor ceramic composition may contain small quantities, in particular quantities of less than 0.5 wt. % in relation to the overall composition, of impurities having the educts, such as TiO₂ or BaCO₃. In addition, it is conceivable that the semiconductor ceramic composition may contain small amounts of sintering aids, in particular less than 5 wt.-% in relation to the overall composition of sintering aids. Sintering aids are added, for example, in order to achieve a lower sintering temperature.

In the formula of the main component of the inventive semiconductor ceramic composition, R represents at least one element selected from the group consisting of Y, La, Ce, Pr, Nd, Sm, Eu, Gd, Tb, Dy, Ho, Er, Tm, Yb. A represents at least one element selected from group consisting of V, Nb, and Ta, and variables b, c, s, p, x, t, a, m, and z are defined as follows:

$$b = 1 - c - s - p - x$$

$$0 < c + s + p < 0.51$$

$$0.49 < b < 0.9 \; 99$$

$$0. < c < 0.5$$

$$0. < s < 0.5$$

$$0.05 < p < 0.5$$

$$0.001 < x < 0.01$$

$$1.0001 < ( t + a + m ) < 1.011575$$

$$0.9889 < t < 1.000375$$

$$0.0001 < a < 0.0 \; 012$$

$$0.0001 < m < 0.01$$

$$0.0001 < z < 0.01 .$$

Surprisingly, it has been shown that the punch-through voltage can be significantly increased by the doping with R and A according to the invention, a so-called co-doping with R and A. Without wishing to be restricted by this declaration, the inventors assume that, in the case of a simple doping only with R, the trivalent element R is indeed predominantly substituted on the bivalent barium site, but it also substitutes to a small extent on the tetravalent titanium site. The desired donor effect is thereby partially compensated in an undesirable manner. However, the addition of the pentavalent element A counteracts this undesirable effect, because A is installed exclusively on the titanium site and acts here as an additional donor. The co-dosing therefore leads to an increased slope of the resistance-temperature characteristic curve (R(T) characteristic curve) of the PTC ceramic and thus also to an increase in the PTC jump and an increase in the punch-through voltage. The purpose of the addition of lead and/or strontium is to specifically adjust the phase conversion temperature and thus the temperature of the PTC jump. Pure SrTiO₃, for example, crystallizes under normal conditions in the cubic perovskite structure. In the case of pure PbTiO₃, by contrast, the conversion from the tetragonal to the cubic crystal structure takes place only over approx. 475° C. A slight excess of titanium can also lead to the formation of small amounts of titanium-rich phases such as Ba₆Ti₁₇O₄₀ during the manufacturing process. These compounds serve as sintering aids. In addition, the excess titanium in the grain boundary region leads to the formation of barium vacancies, which in turn leads to a large PTC jump. The addition of manganese also leads to acceptor levels at the grain boundaries that have a particularly favorable effect on the PTC properties, so that a steeper R(T) characteristic curve and a larger temperature-based resistance jump are observed.

It has also proven to be advantageous that the semiconductor ceramic composition furthermore contains silicon dioxide, the semiconductor ceramic composition preferably contains a minimum of approx. 0.01 wt.-% to a maximum of approx. 5 wt.-% of silicon dioxide in relation to the mass of the total semiconductor ceramic composition, and more preferably the semiconductor ceramic composition contains a minimum of approx. 0.1 wt.-% to a maximum of approx. 1 wt.-% of silicon dioxide in relation to the mass of the total semiconductor ceramic composition.

The addition of silicon, preferably in the form of silicon dioxide, leads to a lower sintering temperature during the manufacturing process, which, among other things, leads to energy savings. The advantage of silicon dioxide in contrast to Al₂O₃ or ZrO₂ as a sintering aid is that silicon does not negatively impact the electrical properties of the product. Furthermore, it has surprisingly been found that this can advantageously increase the punch-through voltage.

In an advantageous further development of the semiconductor ceramic composition, R represents at least one element selected from the group consisting of Y, La, Ce, Pr, Nd, Sm, Gd, Tb, Dy, Ho, and Er, and R preferably represents at least one element selected from the group consisting of Y and La, and more preferably R represents the element Y. This leads to particularly good PTC properties being achieved.

In a further advantageous further development of the semiconductor ceramic composition, A represents the element Nb. In particular, a favorable donor effect can thus be achieved.

Furthermore, it has proven advantageous that the variables t, a, and m assume values in the range of the following limits:

$$0.9985 < t < 1.000075$$

$$0.0002 < a < 0.0 \; 006$$

$$0.0003 < m < 0.001 .$$

Surprisingly, it has been shown that this advantageous composition is associated with a particularly advantageous PTC effect.

In particular, it has proven advantageous that the variables b, c, s, p, x, t, a, m assume the following values:

$$b = 0 \text{.627}$$

$$c = 0. 12$$

$$s = 0. 03$$

$$p = 0. 22$$

$$x = 0. 0 \; 03$$

$$t = 0. 999 \; 625$$

$$a = 0. 0 \; 003$$

$$m = 0. 00065 .$$

A particularly advantageous chemical composition can thus comprise the following stoichiometric formula:

[Ba_{0.627}Ca_{0.12}Sr_{0.03}Pb_{0.22}Y_{0.003}][Ti_{0.999625}Nb_{0.0003}Mn_{0.00065}]O_{3.00065}.

The chemical composition can be determined by chemical analysis methods such as ICP-OES (optical emission spectrometry with inductively coupled plasma).

The invention further relates to a semiconductor ceramic comprising a sintered body having a semiconductor ceramic composition as explained above.

A sintered body is understood by a person skilled in the art to mean the workpiece, for example a ceramic, that is created during sintering. Precisely prepared fine-grained ceramic starting materials, for example, are heated.

The invention further relates to a method for producing a semiconductor ceramic having a sintered body having a semiconductor ceramic composition as explained above, comprising the following steps:
a) Weighing-in of raw materials
b) Mixed grinding
c) Drying and pre-granulation
d) Calcining
e) Fine grinding
f) Spray granulating
g) Pressing
h) Debinding and sintering.

In step a), the starting materials are first prepared and weighed out in precisely defined quantities. For example, oxides, carbonates, and sulfates such as TiO2, BaCO3, Pb3O4, Nb2O3, La2O3, MnCO3 or MnSO4 or Mn(CH3COO)2 can be used as starting materials. It has proven advantageous that the starting materials were sufficiently dried before weighing-in, i.e. they were in anhydrous or almost anhydrous form in order to avoid weighing-in errors. The doping elements can also be added, for example, in the form of chlorides, acetates, or oxalates, such as YCl₃ or Y(CH₃COO)₃. Here, the addition of acetates is advantageously preferred over the addition of chlorides, because the acetate anion is converted to CO₂ and H₂O without residue during the subsequent treatment, while chloride residues may remain in the product. Typically, after weighing-in of the doping elements, a dispersion in deionized water is carried out in order to subsequently ensure a homogeneous distribution of the doping elements in the end product. Alternatively, it is also conceivable that the doping elements are not added until just before the fine grinding in step e).

Then, a mixed grinding takes place in step b). Here, the starting materials are brought to an approx. equal particle size in mills with ZrO₂ grinding balls with the addition of deionized water and, if necessary, organic aids such as dispersing agents and PVA (polyvinaly acetate) or PVB (polyvinyl butyral) and mixed intensively. Drum mills, basket mills, or planetary ball mills, for example, can be used as mills in this context. For example, it is conceivable that a grinding in a planetary ball mill takes place for 4 h at 200 rotations per minute and with ZrO₂ grinding balls with a diameter of 2 mm.

When selecting and weighing-in the starting materials as well as the crucible materials and grinding tools used, it must also be noted that in particular impurities having iron have a disadvantageous effect on the desired electrical properties of the PTC material. It is therefore preferred that potential amounts of iron impurities be less than 100 ppm and in particular less than 10 ppm. Accordingly, the same applies to impurities having alkali metal elements. For example, it has proven advantageous that the TiO₂ starting material has a maximum of the following impurities: K max. 20 ppm, Mg max. 10 ppm, Al max. 20 ppm, Fe max. 10 ppm, Cl max. 100 ppm, Na max. 20 ppm, Nb max. 100 ppm, Zr max. 300 ppm, P max. 100 ppm, S max. 100 ppm, Sb, Ca, V, Co, Ni, Bi, Zn, Cu, B, Cr each max. 10 ppm. To avoid contaminations, it is also conceivable to use plastic coatings where metallic bodies are in direct contact with the powders and compacts used, such as in grinding containers. In addition, it is also conceivable to use particularly abrasion-resistant materials, such as tungsten carbide or locally hardened materials, for example in grinding containers or pressing tools.

The mixture obtained in step b) is then dried in step c). In principle, all methods for drying known to a person skilled in the art, such as with a filter press and drying in a drying cabinet, are conceivable. In this case, the liquid is typically pressed through a filter paper, and the resulting filter residue is then dried. For example, drying in the drying cabinet can take place for about 14 h at about 200° C. However, it has proven to be particularly advantageous to carry out a spray drying in spray dryers known to the person skilled in the art. With regard to spray drying, for example, the more detailed explanation below applies in connection with step f). One advantage of the latter is that the pre-granulate produced in this way can be processed more easily. It is conceivable that a coarse grain portion is separated from the pre-granulate obtained by means of a sieving (300 μm upper limit).

After drying in step c), a temperature treatment for calcining takes place in step d). The powder obtained in step c) is placed in a calcination capsule, for example, and then calcined at temperatures between 90° and 1200° C. in air for a period between a minimum of approx. 0.5 h and a maximum of approx. 4 h. Typical calcining parameters are, for example, 1050° C. for 2 h. During calcining, the raw powders are thermally decomposed, and BaTiO₃ forms as a precursor.

It is conceivable to perform the calcining in a chamber furnace in batch mode or in a continuous pusher-type furnace with ceramic capsules or in a rotary furnace.

In order to avoid contamination of the product, preferably high-temperature stable steels are also used as furnace pipes, such as Alloy 600 or Alloy 602. For example, yttrium-stabilized zirconium oxide capsules or cordierite can be used as ceramic capsules.

After calcining in step d), fine grinding takes place in step e). This is typically done in a ball mill. Fine grinding is advantageously carried out in deionized water with organic aids, such as dispersing agents, defoamers, and polymeric binders and PVA (polyvinyl acetate) or PVB (polyvinyl butyral). For example, it is conceivable that the fine grinding takes place in a planetary ball mill for 6 h at 200 rotations per minute and ZrO₂ grinding balls with a diameter of 2 mm. For fine grinding, one or more organic pressing binders are added either immediately at the start of fine grinding or, alternatively, in the last 15 minutes of fine grinding. Examples of such pressing binders are polyethylene glycol, polyvinyl acetate, or methyl cellulose. Alternatively, the organic aids can also be added for a separate post-grinding step.

Fine grinding is mandatory for the subsequent spray granulation.

Usually, particle sizes d₉₀ of approx. <10 μm and d₅₀ of approx. <3 μm, preferably a d₅₀ of approx. <2 μm, are obtained through fine grinding. However, it is advantageously intended that up to particle sizes d₅₀ of ≤1 μm be ground in order to achieve smaller particle sizes during sintering, which leads to an increase in the punch-through voltage.

The diameter value d₅₀ indicates the particle diameter below which 50% of all particles can be found. Conversely, this also means that 50% of all particles have a larger particle diameter. The diameter value d₉₀ indicates the particle diameter below which 90% of all particles can be found. It goes without saying that such hollow spheres may have a geometry that deviates slightly from the ideal sphere due to the manufacturing process. Typically, the diameters of such hollow spheres are determined using laser diffraction or automated statistical imaging.

This is followed by spray granulation or spray drying. In principle, a spray drying can be carried out in all spray dryers known to the person skilled in the art. For example, the suspension/dispersion can be added to the spray dryer by means of a pump. Then, a nozzle injection of dry air and dispersion/suspension can be carried out using the counter-current principle or direct-current principle. Parameters for spray drying can be, for example, a minimum of approx. 170° C. to a maximum of approx. 220° C. for the supply air temperature, a minimum of approx. 80° C. and a maximum of approx. 110° C. for the exhaust air temperature, and a low negative pressure of approx. 0.6 kPa. Alternatively, the injection can also be carried out in the rotary spray dryer via a rotating atomizer nozzle (typically 20,000 rpm). The advantage here is that the additional centrifugal force obtains a particle shape that is closer to an ideal spherical shape.

In the present case, spray drying typically leads to a granulate moisture of approx. <15% and to granulate sizes (d₅₀) of approx. less than 100 μm, which is particularly advantageous for homogeneity, insertion into the pressing tool, and pressability. In particular, it was surprisingly shown that this also leads to an increase in the punch-through voltage.

Furthermore, it has proven advantageous to use magnetic filters to avoid or minimize critical metal impurities in the manufacturing process.

The granulate is then pressed in step g). In principle, pressing in all presses known to a person skilled in the art is possible. For example, a dry-pressing can be carried out with a mechanical linear press having a top and bottom punch, wherein a pressure of approx. 6.6 kN is typically used in an individual part having a geometry that is optimized for a heating application. The typical press density is about 3.2 to 3.3 g/cm³. Alternatively, for example, pressing in a rotary press is also conceivable.

Then, step g) is performed in step h), and the obtained pellet is debinded and sintered. This can be carried out in two separate furnaces or in one furnace. Preferably, the debinding and sintering take place in a furnace. The furnace can be a sintering furnace having a plurality of sections, wherein there can be debinding zones with a high air flow rate, sintering zones, and cooling zones. For example, it is conceivable to pretreat the pellet for 2 to 4 hours at 150 to 400° C., depending on the pressing binder used, until all organic residues have been removed. Here, a slow heating and, as a result, an avoidance of crack formation has proven to be advantageous for achieving an optimum punch-through voltage. The obtained green compact is then brought into the sintering zone of the furnace, for example. The sintering is typically done in air at temperatures of a minimum of approx. 1200 to a maximum of approx. 1400° C. with hold times between approx. 0.5 and 4 h. Typical sintering parameters are, for example, approx. 1300° C. for approx. 1 h. Then, there is a cooling to room temperature. For example, the cooling can take place at a cooling rate of a minimum of approx. 2 K/min to a maximum of approx. 10 K/min.

Then, the sintering is typically followed by polishing to the required geometry on the cooled sintered body. Polishing removes the sintered skin, resulting in a more homogeneous structure and better electrical properties. Polishing must be done gently in order to avoid the introduction of micro-cracks and to reduce the punch-through voltage.

The invention further relates to a PTC thermistor having a sintered body, wherein the sintered body has a semiconductor ceramic composition as explained above, as well as electrodes on the surface of the sintered body.

A thermistor is understood by a person skilled in the art to be a variable and heat-sensitive electrical resistor having a temperature characteristic comprising a non-linearity whose value changes reproducibly with the temperature. In the present case, the sintered body, which comprises the semiconductor ceramic composition as explained above, has a metallization on two opposing surfaces. This is used for electrical contacting.

In principle, all metallization layers known to a person skilled in the art, which can serve for electrical contacting on the surface of the sintered body, are conceivable. It has proven to be particularly advantageous when the metallization comprises a Cr layer having a thickness of approx. 0.1 μm on the sintered body and a further layer on the Cr layer consisting of nickel or a nickel alloy having a thickness of approx. 0.4 μm. Furthermore, it has proven advantageous when the metallization additionally comprises a layer comprising Ag as the main component and is located on the layer consisting of nickel or a nickel alloy, having a thickness of approx. 7 μm. The Cr and the layer consisting of nickel or a nickel alloy are advantageously applied by means of a PVD method. Furthermore, the layer, which comprises Ag as the main component, is advantageously applied by means of screen printing and subsequent baking.

Of course, the thickness and shape of the PTC semiconductor ceramic can be selected depending on the desired application. For example, for use in a heating apparatus, it has proven advantageous to use a thickness of approx. 2 mm for an operating voltage of approx. 350 V and a thickness of, for example, approx. maximum 2.8 mm to minimum approx. 2.5 mm for an operating voltage of 800 V, and preferably a thickness of approx. 2.5 mm is used at an operating voltage of approx. 800 V. A PTC semiconductor ceramic as described above typically has a ρ(T) curve in the small signal ranges (so-called measurement at low voltage)≤1.5 V as shown in FIG. 5.

In addition, the invention relates to the use of a semiconductor ceramic having the semiconductor ceramic composition as explained above in a high-voltage heating application, a switching element, a measuring element, or a temperature control element, and preferably the semiconductor ceramic is used in a high-voltage heating application.

In this context, the application as a PTC heating element for a vehicle having a high on-board voltage of at least approx. 350 V and preferably ≥800 V is suggested as the high-voltage application.

In addition, an application as over-voltage protection, as a switch with the possibility of delay, as an over-temperature protection, or as an switch-on current limiter is conceivable.

Further important features and advantages of the invention can be seen from the sub-claims, from the drawings and the associated description of the figures and from the example.

It goes without saying that the above-mentioned features and those to be explained below can be used not only in the combination indicated in each case, but also in other combinations or on their own, without going beyond the scope of the present invention.

### BRIEF DESCRIPTION OF THE DRAWINGS

FIG. 1 is a schematic general illustration of the voltage-current characteristic curve of a PTC component.

FIG. 2 is a schematic illustration of an example of a semiconductor ceramic with metallization on two opposing sides.

FIG. 3 is a schematic illustration of the inventive method for the production of a semiconductor ceramic.

FIG. 4 is a schematic illustration of a high-voltage air heater.

FIG. 5 shows a typical curve of the specific electrical resistance p with the temperature T for the PTC ceramic according to the invention.

### DETAILED DESCRIPTION

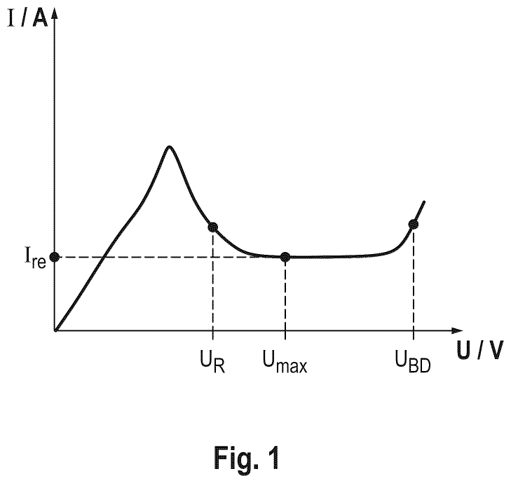

FIG. 1 shows a schematic illustration of a typical voltage-current characteristic curve of a PCT component. Here, U_{R} represents the nominal voltage, for example 350 V or 800 V, for which the PCT ceramic is designed. Uₘₐₓ is the maximum voltage that is present when the battery is fully charged. Iᵣₑ represents the corresponding maximum current that flows when Uₘₐₓ is present. U_{BD} represents the punch-through voltage.

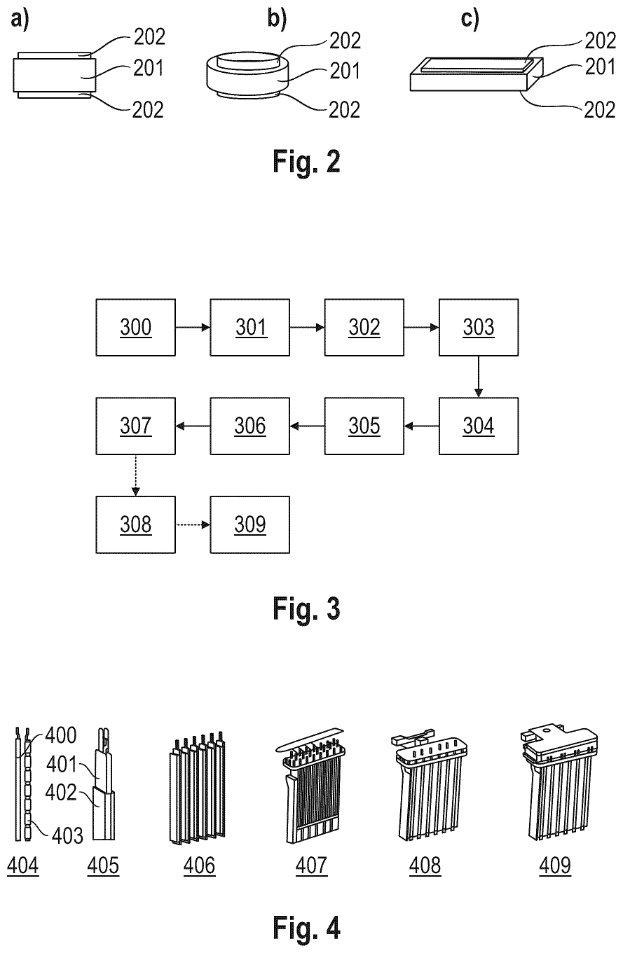

FIG. 2 a) shows an example of a PTC semiconductor ceramic having a sintered body 201 according to a semiconductor ceramic composition proposed in the present application. The semiconductor ceramic 201 is in this case coated on two opposing [sic: sides] with a metal layer 202, which can be used for electrical contacting. As can be seen from FIG. 1 b) and FIG. 1 c), it is conceivable that this is a cylindrical arrangement (tablet), and it is also conceivable that the arrangement is designed in a box-shaped manner (cuboid). In this context, it should be noted that a metal layer is also present on the two opposing sides in FIG. 2c, wherein one side is not shown in the perspective illustration. A cuboid shape is advantageously used.

FIG. 3 first shows in method step a) a weighing-in of raw materials 300. It is conceivable that all weighed-in starting materials are combined in the subsequent step b). Alternatively, however, it is conceivable that, for example, the doped elements and/or SiO₂ are not added until step e). A mixed grinding 301 takes place in step b). Then, a drying and pre-granulation 302 takes place in step c). In step d), a calcining 303 of the previously obtained granulate takes place. This is followed in step e) by a fine grinding 304. In the event that not all weighed-in starting materials have already been added in step b), the remaining starting materials are now added in step e). After the fine grinding 304, particle sizes d₉₀ of approx. <10 μm and d₅₀ of approx. <3 μm are preferably present, preferably a d₅₀ of approx. <2 μm. Particle sizes d₅₀ of ≤1 μm are particularly preferred. This is followed by the spray granulation 305 in step f). This preferably leads to a granulate moisture of approx. <15% and to granulate sizes (d₅₀) of approx. less than 100 μm. In step g), a pressing 306 then takes place, followed by a debinding and sintering 307 in step h).

For all method steps a) to h), unless otherwise described, the foregoing applies in connection with the method steps.

In a further step, it is optionally conceivable for the obtained and cooled sintered body to be polished to the shape required for the desired application, 308. Furthermore, a metallization 309 can optionally occur after polishing, i.e. metal layers that enable electrical contacting are applied on two opposing sides of the sintered body.

FIG. 4 schematically shows the design of a high-voltage air heater. Here, a PTC heating element 403 is contacted by an Al contact film 400. These two elements are in turn insulated by an Al₂O₃ insulation 401 and are located in an Al tube 402 in the form of a cemented PTC heating element 405 with contacting and insulation. Six such modules are in turn electrically connected to one another 406 and can be installed in a housing 407. Together with a control unit and a terminal, the element 408 results. The latter is in turn equipped with a cover for the control unit and results in the ready-to-use electrical PTC heater 409.

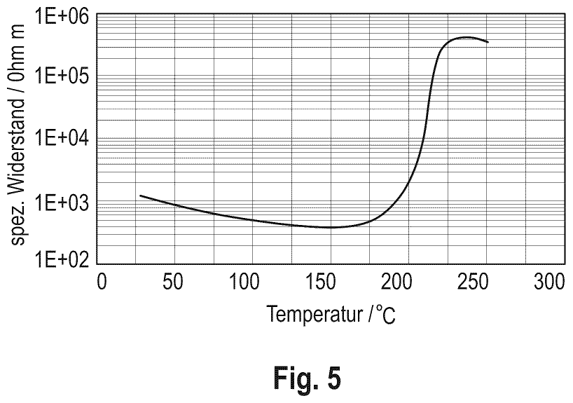

FIG. 5 shows a typical curve of the specific electrical resistance p at the temperature (ρ(T) curve) of the PTC ceramic according to the invention. The geometry of the PTC ceramic has been calculated. Here, a strong increase in the specific resistance can be seen in the range of the phase conversion as described above.

In the following, the invention is described in detail by means of an example, without the scope of the invention being limited thereto:

### Materials Used:

BaCO₃, CaCO₃, SrCO₃, Nb₂O₅, Y₂O₃, PbO₂, TiO₂, Mn(CH₃COO)₂, SiO₂

### Inventive Example IE1

A semiconductor ceramic having the following semiconductor ceramic composition is produced.

[Ba_{b}Ca_{c}SrₛPbₚRₓ][TiₜAₐMnₘ]O_{3+z}.

where

R: Y

A Nb

b: 0.627

c: 0.12

s: 0.03

p: 0.22

x: 0.003

t: 0.999625

a: 0.0003

m: 0.00065

z: 0.00065

and 0.3 wt.-% SiO₂.

### Implementation:

First, the starting materials BaCO₃, CaCO₃, SrCO₃, Nb₂O₅, Y₂O₃, PbO₂, TiO₂ were weighed in. A mixed grinding was then carried out in a suspension of deionized water for 4 h in a planetary ball mill (200 rpm; grinding balls: ZrO2, Ø2 mm). Then, the powder was pestled and sieved, dried in a drying cabinet at a temperature of 120° C. for 14 h, and calcined for 2 h at 1000° C.

Then, Mn(CH₃COO)₂ was added. In addition, SiO₂ was added with a share of 0.3 wt. % in relation to the total composition. This mixture was then fine-ground in a planetary ball mill (duration: 6 h; 200 rotations/min, grinding balls: ZrO₂, Ø2 mm). Unlike mixed grinding, in this case grinding was carried out in a suspension with isopropanol. Furthermore, a binder (PVB) was also added to the suspension during the fine grinding. The subsequent spray drying was carried out at a gas inlet temperature of 170° C. and a gas outlet temperature of 85° C. After spray granulation, the d₉₀ of the granulate was 74 μm and the bulk density was 1.28 g/cm³.

The granules obtained were pressed by uniaxial pressing to green densities of approx. 3.4 g/cm³. The sintering was performed at T=1300° C. and a hold time of 1 h using sintering aids consisting of zirconium oxide.

The sintered skin of the obtained blanks was then polished away and purified using deionized water and isopropanol. For contacting, one layer of Al paste (thickness: approx. 10 m) was applied to the respective end faces of the polished sintered bodies. This was dried at a temperature of 150° C. for 15 min and then baked in at a temperature of 720° C. and a hold time of 15 min.

The parts contacted with Al were then electrically measured, i.e. a ρ-T curve of the parts was measured (see FIG. 5).

1. A semiconductor ceramic composition, comprising, as a main component, a BaTiO₃-based compound according to the formula [Ba_{b}Ca_{c}SrₛPbₚRₓ][TiₜAₐMnₘ]O_{3+z}, wherein:
R represents at least one element selected from a group consisting of Y, La, Ce, Pr, Nd, Sm, Eu, Gd, Tb, Dy, Ho, Er, Tm, and Yb;
A represents at least one element selected from a group consisting of V, Nb, and Ta; and
the variables b, c, s, p, x, t, a, m, and z are defined as follows:
$$b = 1 - c - s - p - x ;$$
$$0 < c + s + p < 0.51 ;$$
$$0.49 < b < 0.999 ;$$
$$0. < c < 0.5 ;$$
$$0. < s < 0.5 ;$$
$$0.05 < p < 0.5 ;$$
$$0.001 < x < 0.01 ;$$
$$1.0001 < ( t + a + m ) < 1.0 \; 11575 ;$$
$$0.9889 < t < 1.0 \; 00375 ;$$
$$0.0001 < a < 0 \text{.0012} ;$$
$$0.0001 < m < 0.01 ;$$
$$and$$
$$0.0001 < z < 0.01 .$$

2. The semiconductor ceramic composition according to claim 1, further comprising silicon dioxide.

3. The semiconductor ceramic composition according to claim 1, wherein R represents at least one element selected from a group consisting of Y, La, Ce, Pr, Nd, Sm, Gd, Tb, Dy, Ho, and Er.

4. The semiconductor ceramic composition according to claim 1, wherein A represents the element Nb.

5. The semiconductor ceramic composition according to claim 1, wherein the variables t, a, and m assume values as follows:
$$0.9985 < t < 1.0 \; 00075 ;$$
$$0.0002 < a < 0.0006 ;$$
$$and$$
$$0.0003 < m < 0.001 .$$

6. The semiconductor ceramic composition according to claim 1, wherein the variables b, c, s, p, x, t, a, m assume values as follows:
$$b = 0.627 ;$$
$$c = 0.12 ;$$
$$s = 0.03 ;$$
$$p = 0.22 ;$$
$$x = 0.003 ;$$
$$t = 0. 999625 ;$$
$$a = 0.0003 ;$$
$$and$$
$$m = \_ 0.00065 .$$

7. A semiconductor ceramic, comprising a sintered body having the semiconductor ceramic composition according to claim 1.

8. A method for producing a semiconductor ceramic with a sintered body having the semiconductor ceramic composition according to claim 1, the method comprising:
weighing-in of raw materials;
mixed grinding;
drying and pre-granulation;
calcining;
fine grinding;
spray granulating;
pressing; and
debinding and sintering.

9. A PTC thermistor, comprising:
a sintered body having the semiconductor ceramic composition according to claim 1; and
a plurality of electrodes disposed on a surface of the sintered body.

10. A use of a semiconductor ceramic having the semiconductor ceramic composition according to claim 1 in at least one of a high-voltage heating application, a switching element, a measuring element, and a temperature control element.

11. The semiconductor ceramic composition according to claim 1, further comprising impurities that account for 0.5 wt.-% or less of a total mass of the semiconductor ceramic composition.

12. The semiconductor ceramic composition according to claim 1, further comprising at least one sintering aid.

13. The semiconductor ceramic composition according to claim 2, wherein the silicon dioxide accounts for approximately 0.01 wt.-% to 5 wt.-% of a total mass of the semiconductor ceramic composition.

14. The semiconductor ceramic composition according to claim 13, wherein the silicon dioxide accounts for approximately 0.1 wt.-% to 1 wt.-% of the total mass of the semiconductor ceramic composition.

15. The semiconductor ceramic composition according to claim 3, wherein R represents at least one of the element Y and the element La.

16. The semiconductor ceramic composition according to claim 15, wherein R represents the element Y.

17. The semiconductor ceramic composition according to claim 5, wherein A represents the element Nb.

18. The semiconductor ceramic composition according to claim 17, wherein R represents at least one of the element Y and the element La.

19. The semiconductor ceramic composition according to claim 6, wherein:
R represents the element Y; and
A represents the element Nb.

20. The semiconductor ceramic composition according to claim 19, further comprising silicon dioxide.
